(19) United States
(12) Patent Application Publication
(10) Pub. No.: US 2010/0111627 A1
(43) Pub. Date: May 6, 2010

(54) Indexable Insert for Drilling and Blank Insert Manufacturing Same

(75) Inventor: Byung Gyun Bae, Daegu (KR)

Correspondence Address: WOMBLE CARLYLE SANDRIDGE & RICE, PLLC, ATTN: PATENT DOCKETING, P.O. BOX 7037, ATLANTA, GA, 30357-0037, US

(73) Assignee: TaeguTec,Ltd., Daegu (KR)

(21) Appl. No.: 12/525,033

(22) PCT Filed: Jan. 30, 2007
(86) PCT No.: PCT/KR07/00516

§ 371 Date: Jul. 29, 2009

(51) Int. Cl. B23B 51/00; B23B 51/02

(52) U.S. Cl. 408/200; 76/108.1; 451/48

(57) ABSTRACT

An indexable insert for drilling includes front and rear edges opposite to each other and having a rotationally symmetrical relation; and two side surfaces opposite to each other and having a rotationally symmetrical relation. Each side surface has first and second cutting edge portions formed thereon. The first cutting edge portion is disposed farther than the second cutting edge from the center of the blank insert, thereby providing a step between the first and second cutting edge. The first cutting edge is adjacent to the front edge.

### TECHNICAL FIELD

The present invention generally relates to an indexable insert for drilling and a blank insert for manufacturing the same. More particularly, the present invention relates to two or more indexable inserts mounted to a distal end of a drill body in a rotationally symmetrical relation and a blank insert for manufacturing the same.

### BACKGROUND ART

A drill can be divided into a solid-type drill and a throwaway-type drill depending on whether a cutting edge is integrally or separately formed with a drill body. Further, the throwaway-type drill can be divided into a dual-cutting (also referred to as ‘double-effective’) drill, the cutting inserts of which are symmetrically mounted, and a half-effective drill, the cutting inserts of which are non-symmetrically mounted, depending on whether or not the cutting inserts are symmetrically mounted to the drill body relative to a longitudinal axis of the drill body.

FIGS. 1 and 2 illustrate a conventional throwaway-type dual cutting drill. As shown in FIG. 1, the drill is constructed to use an indexable cutting insert (1a). In such a construction, when cutting edges of the cutting insert (1a) become worn out or damaged, the cutting insert (1a) can be rotated to use other edges as cutting edges, thereby eliminating the need to immediately replace the cutting insert (1a) with a new one. Thus, the above construction is very efficient and economical.

It is also economical if various sizes of inserts can be manufactured from a blank insert with the same design and used with one drill body. However, in the drill constructed as shown in FIG. 1, it is difficult to use various sizes of inserts with one drill body. For instance, in the drill shown in FIG. 1, when using a cutting insert (1a) having a smaller size than the cutting insert (1a) currently mounted to the drill, a distance from the center of the cutting insert (1a) to a side cutting edge (3a) become shorter than before. Further, the cutting insert (1a) shown FIG. 1 is an indexable insert. Thus, a distance from the center of the cutting insert (1a) to a side edge (3a′) opposite to the side cutting edge (3a) also becomes shorter as such. In such a case, the shape of the cutting edge at the central cutting region (c) becomes different than before. As such, the drill fails to maintain the same cutting mechanism as before.

If the cutting mechanism can be maintained the same regardless of the change in drill diameter due to a change in insert size, then there is an advantage in that when different results are obtained due to a change in certain conditions, the factor for causing such results can be easily found. For instance, the above advantage would apply to a case in which only a material for a work piece is changed while maintaining the cutting mechanism to be the same. In such a case, if a problem occurs in that the durability of a tool was lower, then it can be easily found that such a problem was caused by the material of the work piece.

In the drill shown in FIG. 1, when mounting various sizes of inserts to one drill body, the shape of the cutting edge at the central cutting region (c) varies, thereby failing to maintain the same cutting mechanism. Thus, in the above drill, it is difficult to use various sizes of the inserts with one drill body.

FIG. 2 illustrates a drill using a normal cutting insert (1b), which is not an indexable insert. In such a drill, even if a side cutting edge (3b) of the cutting insert (1b) is shifted towards the inside of the cutting insert (1b) to achieve a smaller drill diameter, there is no need to change the position of a cutting edge at the central cutting region (c), which corresponds to the side cutting edge (3b). Thus, the cutting insert (1b) having such a configuration does not change the shape of the cutting edge at the central cutting region (c) even if the size of the cutting insert (1b) varies. This makes it possible to maintain the same cutting mechanism. However, since the cutting insert (1b) is not an indexable insert, a problem exists in that if a cutting edge becomes worn out or damaged, then the insert (1b) must be replaced with a new one while being impossible to rotate it for use.

As such, the drill shown in FIG. 1 can reduce the costs associated with the cutting insert by using the indexable cutting insert. However, there is a limitation in achieving various drill diameters relative to one drill body. The drill shown in FIG. 2 can achieve various drill diameters relative to one drill body. However, there is a problem in that other edges of the cutting insert cannot be used as cutting edges when the cutting edges become worn out or damaged.

### DISCLOSURE

### Technical Problem

It is an objective of the present invention to provide an indexable insert for drilling, which can constantly maintain the shape of a cutting edge at the central cutting region in spite of indexing, and a blank insert for manufacturing such an indexable insert, thereby solving the problem of the prior art.

### Technical Solution

In order to achieve the above objective, the present invention provides a blank insert for an indexable insert for drilling, comprising: front and rear edges opposite to each other and having a rotationally symmetrical relation; and two side surfaces opposite to each other and having a rotationally symmetrical relation. Each side surface has first and second cutting edge portions formed thereon. The first cutting edge portion is disposed farther than the second cutting edge portion from the center of the blank insert, thereby providing a step between the first and second cutting edge portions. The first cutting edge portion is adjacent to the front edge.

Further, the present invention provides an indexable insert for drilling, comprising: front and rear edges opposite to each other and having a rotationally symmetrical relation; and two side surfaces opposite to each other and having a rotationally symmetrical relation. Each side surface has first and second cutting edge portions formed thereon. The first cutting edge portion is disposed farther than the second cutting edge portion from the center of the insert, thereby providing a step between the first and second cutting edge portions. The first cutting edge portion is adjacent to the front edge.

Furthermore, the present invention provides an indexable insert for drilling, which is manufactured by powder metallurgy, while the second cutting edge is not formed in a grinding process.

### DESCRIPTION OF DRAWINGS

FIGS. 1 and 2 are perspective views illustrating conventional throwaway-type and dual cutting drills.

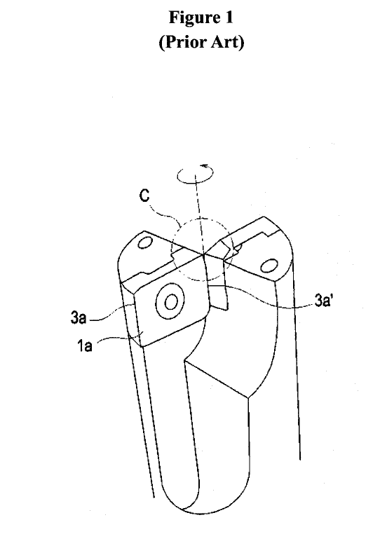

FIG. 3 is a perspective view illustrating a throwaway-type and dual cutting drill to which cutting inserts are mounted in accordance with one embodiment of the present invention.

FIG. 4 is a side view and a partially enlarged view illustrating the drill shown in FIG. 3.

FIG. 5 is a perspective view illustrating a blank insert in accordance with one embodiment of the present invention.

FIG. 6 is front, left and bottom views illustrating a cutting insert manufactured from the blank insert shown in FIG. 5.

FIG. 7 is a perspective view illustrating the cutting insert shown in FIG. 6.

FIG. 8 is a plan view illustrating the cutting inserts taken from the drill shown in FIG. 3 or 4.

### BEST MODE FOR CARRYING OUT THE INVENTION

Features and advantages of the present invention will now be more apparent with reference to the accompanying drawings.

Hereinafter, the same reference numeral will be used for the same element and only different element will be described so as not to describe the same element repeatedly when describing embodiments of the present invention with reference to the drawings.

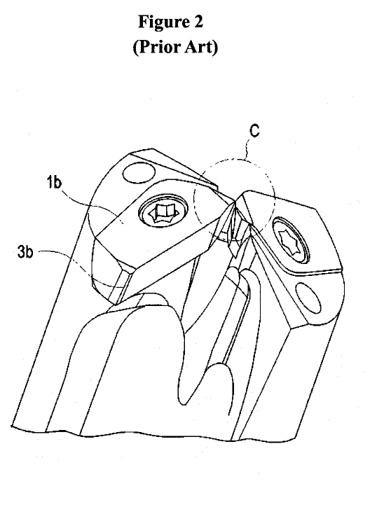

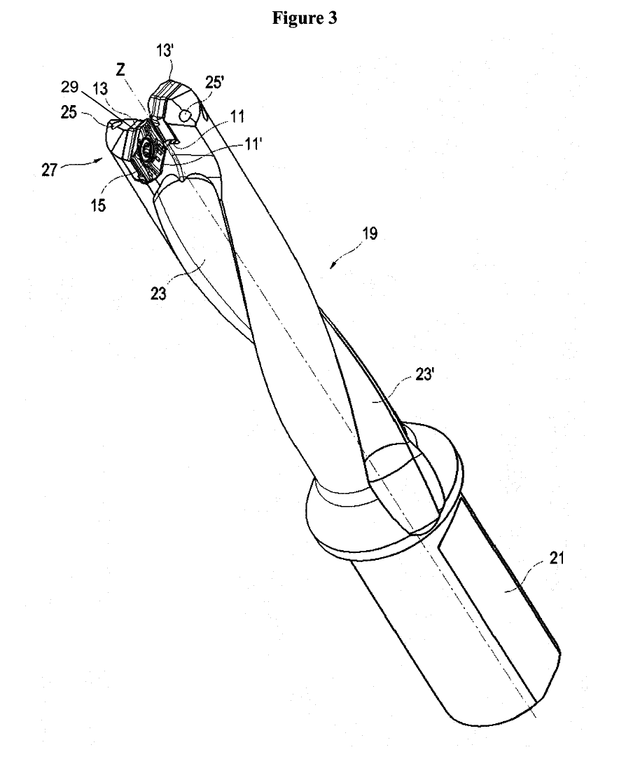

FIGS. 3 and 4 illustrate a throwaway-type and a dual cutting drill to which cutting inserts are mounted in accordance with one embodiment of the present invention. The drill comprises a drill body (19) and an indexable cutting insert (13, 13′), which is mounted to a distal end (27) of the drill body (19). The drill body (19) includes a shank, (21) which is retained in an adaptor of a spindle (not shown), and flutes (23, 23′) that provide passages for exhausting chips. The drill body (19) also has flow passages (25, 25′) for refrigerant.

The distal end (27) of the drill body (19) has recesses (11, 11′) in which indexable inserts (13, 13′) are received. Each recess (11, 11′) has a base face on which the cutting insert (13, 13′) is mounted. A screw hole (not shown) is formed on the base face. A via-hole is formed on the center of the cutting insert (13, 13′). The cutting insert (13, 13′) is fixed to the drill body (19) by a locking screw (15) fastened in the screw hole, which is formed on the base face of the recess (11, 11′), via the via-hole of the cutting insert (13, 13′). When disassembling the insert (13, 13′) for replacing or indexing, the locking screw must be removed. The cutting inserts (13, 13′) are mounted to the drill body (19) with a rotationally symmetric relation to each other in the longitudinal axis (Z) of the drill body (19).

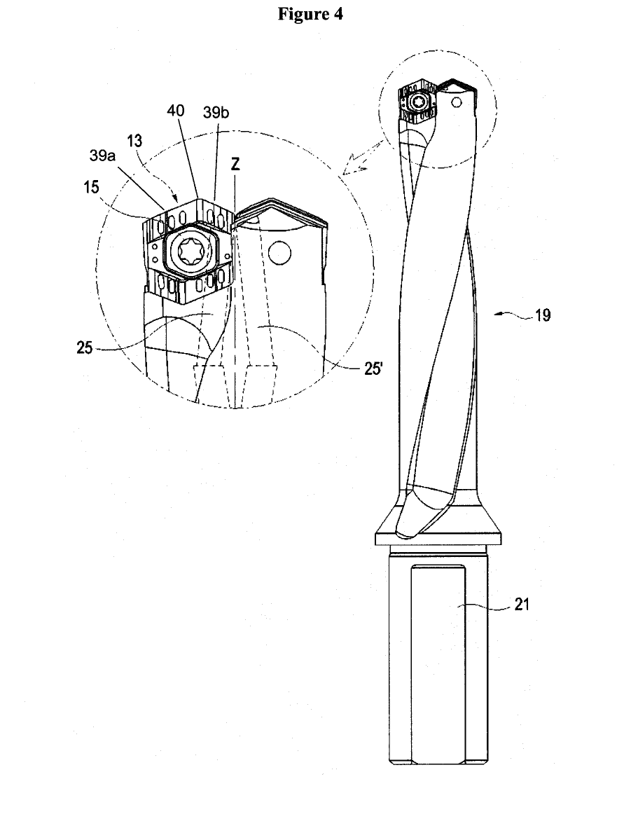

FIG. 5 illustrates a blank insert (30) in accordance with one embodiment of the present invention. The blank insert (30) comprises a front edge (29) and a rear edge (29′), which are opposite to each other. The front edge (29) and the rear edge (29′) have a rotationally symmetrical relation in the central axis of the blank insert (30). The blank insert (30) further comprises two side surfaces (34, 34′) opposite to each other. The two side surfaces (34, 34′) have a rotationally symmetrical relation in the central axis of the blank insert (30).

Each side surface (34) of the blank insert (30) has a first cutting edge portion (34a) and a second cutting edge portion (34b) formed thereon. The first cutting edge portion (34a) is disposed farther than the second cutting edge portion (34b) from a center of a blank insert (30), thereby providing a step between the first cutting edge portion (34a) and the second cutting edge portion (34b). The first cutting edge portion (34a) is adjacent to the front edge (29). The front edge (29) and the first cutting edge portion (34a) are manufactured by a grinding process. Various drill diameters can be achieved by adjusting the amount of grinding. The second cutting edge portion (34b) is not used in side cutting of a hole that will be drilled. Thus, the second cutting edge portion (34b) can be used without any grinding process.

The blank insert (30) can be manufactured by powder metallurgy in which processes of hardening, heating and sintering are performed. The process of hardening includes pressurizing the powder of metallic material (e.g., hard metal) to be hardened. In the shown blank insert (30), the step between the first cutting edge portion (34a) and the second cutting edge portion (34b) is about 0.85 mm. Further, the length ratio of the first cutting edge portion (34a) to the second cutting edge portion (34b) is about 6 to 4. A portion in the center of the front edge (29) of the blank insert (30) is more protruded than two side portions thereof, thereby forming the blank insert (30) in a substantially hexagonal shape.

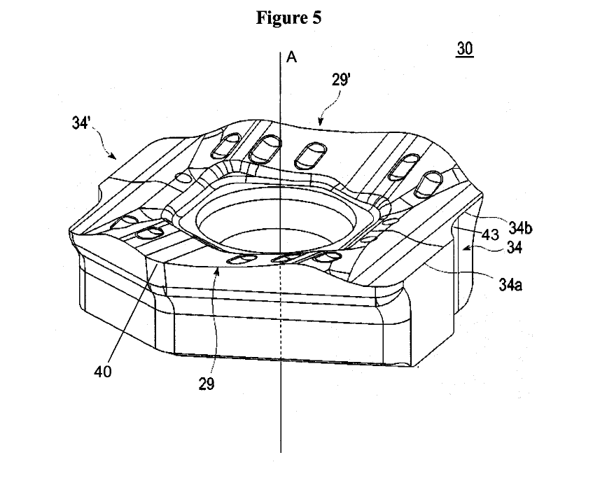

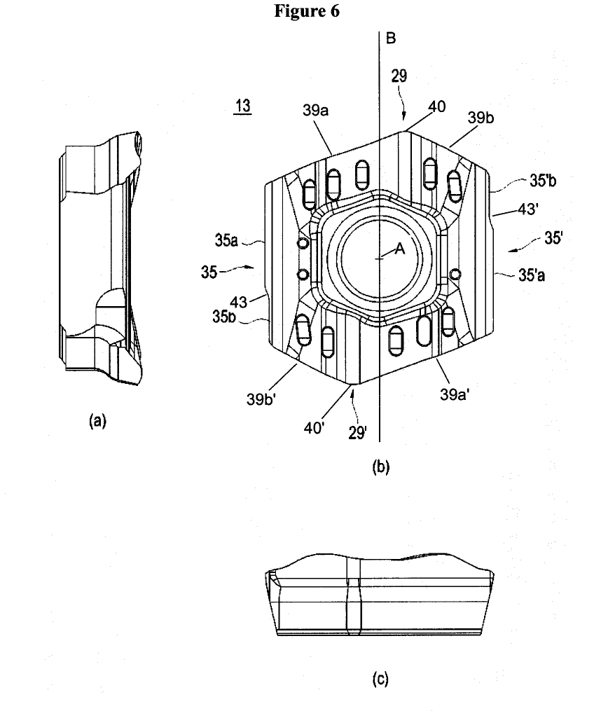

FIGS. 6 and 7 illustrate a cutting insert (13) manufactured from the blank insert (30) shown in FIG. 5. The cutting insert (13) substantially has six edges. Two right and left edges opposite to each other work as side cutting edges (35, 35′) for cutting the side surface of a hole that will be drilled. The other four edges work as a front edge (29) and a rear edge (29′) for cutting bottom surfaces of the hole that will be drilled. With reference to FIGS. 3 and 4, it can be notified that real cutting operation is performed by a first set of the front edge (29) and the side cutting edge (35). The front edge (29′) and the side cutting edge (35′) form a second set. If a portion of the cutting edges in the first set are worn out or damaged, then the second set will be mounted by rotation as 180° in order to perform the cutting operation.

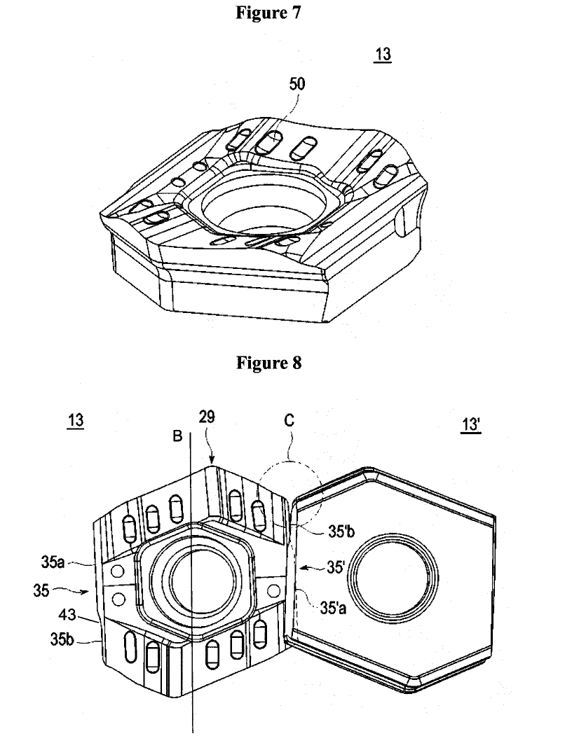

FIG. 8 illustrates the cutting inserts (13, 13′) taken from the drill shown in FIGS. 3 and 4. The cutting insert (13) has the front edge (29) and two side surfaces (35, 35′). The side surface (35) has the first cutting edge (35a) and the second cutting edge (35b) formed thereon. The first cutting edge (35a) is disposed farther than the second cutting edge (35b) from the center of the insert (13), thereby providing a step between the first cutting edge (35a) and the second cutting edge (35b). The first cutting edge (35a) is adjacent to the front edge (29). Thus, when the cutting insert (13) is mounted by the rotation as 180°, the first cutting edge (35a) can be disposed apart from the central cutting region (c).

As described above with reference to FIG. 5, the first cutting edge (35a) can be manufactured with various amounts of grinding from the blank insert (30). When the insert (30) is mounted, various sizes of drill diameters can be achieved depending on the amount of grinding. On the other hand, it is not necessary to manufacture the second cutting edge (35b) with various amounts of grinding to vary the drill diameter. Thus, even if the cutting insert (13) is mounted by the rotation as 180°, the shape of the cutting edge of the central cutting region (c) will not be changed. As such, the drill having the cutting insert (13) can maintain the same cutting mechanism regardless of the change in the drill diameter. Further, as described above, the blank insert (30) is manufactured by powder metallurgy. Thus, although the second cutting edge (35b) is not manufactured by a grinding process, it, can be manufactured to be sharp enough so as to be used as a cutting edge of the central cutting region (c).

As shown in FIG. 7, the cutting insert (13) has a plurality of recesses (50) formed on the top surface thereof. The recesses (50) can make quick transfer of heat generated during the cutting operation, thereby minimizing damage of the cutting insert (13) by the heat.

While the present invention has been particularly shown and described with reference to exemplary embodiments thereof, it will be understood by those of ordinary skill in the art that various alternations or modifications can be made without departing from the scope of the present invention.

### INDUSTRIAL APPLICABILITY

The present invention provides an indexable insert for drilling, which can constantly maintain the shape of a cutting edge at a central cutting region in spite of indexing, and a blank insert for manufacturing such an indexable insert. Thus, various sizes of indexable inserts can be manufactured from a blank insert with the same design and used with one drill body.

1. A blank insert for manufacturing an indexable insert for drilling, comprising:
front and rear edges opposite to each other and having a rotationally symmetrical relation; and
two side surfaces opposite to each other and having a rotationally symmetrical relation;
wherein each side surface has first and second cutting edge portions formed thereon;
wherein the first cutting edge portion is disposed farther than the second cutting edge portion from a longitudinal centerline which passes through both the front and rear edges in a plan view of the blank insert, thereby providing a step between the first and second cutting edge portions; and
wherein the first cutting edge portion of a first side surface is adjacent to the front edge and the first cutting edge portion of a second side surface is adjacent to the rear edge.

2. The blank insert of claim 1, wherein a portion in the middle of the front edge is further protruded than two side portions thereof, thereby forming the blank insert in a substantially hexagonal shape.

3. An indexable insert for drilling, comprising:
front and rear edges opposite to each other and having a rotationally symmetrical relation; and
two side surfaces opposite to each other and having a rotationally symmetrical relation;
wherein each side surface has first and second cutting edges formed thereon;
wherein the first cutting edge is disposed farther than the second cutting edge from a longitudinal centerline which passes through both the front and rear edges in a plan view of the insert, thereby providing a step between the first and second cutting edges; and
wherein the first cutting edge of a first side surface is adjacent to the front edge and the first cutting edge of a second side surface is adjacent to the rear edge.

4. The indexable insert of claim 3, wherein the insert is manufactured by powder metallurgy.

5. The indexable insert of claim 3, wherein the second cutting edge is not formed in a grinding process.

6. The indexable insert of claim 3, wherein a portion in the middle of the front edge is further protruded than two side portions thereof, thereby forming the insert in a substantially hexagonal shape.

7. The indexable insert of claim 3, wherein:
the front edge comprises a front major component edge and a front minor component edge which merge at a front forwardmost portion of the front edge; and
the rear edge comprises a rear major component edge and a rear minor component edge which merge at a rear forwardmost portion of the rear edge.

8. The indexable insert of claim 7, wherein, in a plan view of the insert:
the front major component edge is longer than the front minor component edge;
the rear major component edge is longer than the rear minor component edge; and
the front and rear forwardmost portions are situated on opposite sides of the insert's longitudinal centerline; and
the insert's longitudinal centerline passes through the major front component edge and the major rear component edge.

9. The indexable insert of claim 8, wherein:
the first cutting edge of the first side surface is adjacent to the front major component edge; and
the first cutting edge of the second side surface is adjacent to the rear major component edge.

10. The indexable insert of claim 8, wherein:
the first cutting edge of each of the side surfaces is ground; and
the second cutting edge of each of side surfaces is not ground.

11. The blank insert of claim 1, wherein:
the front edge comprises a front major component edge and a front minor component edge which merge at a front forwardmost portion of the front edge; and
the rear edge comprises a rear major component edge and a rear minor component edge which merge at a rear forwardmost portion of the rear edge.

12. The blank insert of claim 11, wherein, in a plan view of the blank insert:
the front major component edge is longer than the front minor component edge;
the rear major component edge is longer than the rear minor component edge; and
the front and rear forwardmost portions are situated on opposite sides of the blank insert's longitudinal centerline; and
the blank insert's longitudinal centerline passes through the major front component edge and the major rear component edge.

13. The indexable insert of claim 12, wherein:
the first cutting edge portion of the first side surface is adjacent to the front major component edge; and
the first cutting edge portion of the second side surface is adjacent to the rear major component edge.

14. A method of manufacturing a cutting insert for drilling comprising:
(a) providing a blank insert, comprising:
front and rear edges opposite to each other and having a rotationally symmetrical relation; and
two side surfaces opposite to each other and having a rotationally symmetrical relation;
wherein each side surface has first and second cutting edge portions formed thereon;
wherein the first cutting edge portion is disposed farther than the second cutting edge portion from a longitudinal centerline which passes through both the front and rear edges in a plan view of the blank insert, thereby providing a step between the first and second cutting edge portions; and
wherein the first cutting edge portion of a first side surface is adjacent to the front edge and the first cutting edge portion of a second side surface is adjacent to the rear edge; and
(b) grinding only the first cutting edge portions of each of the side surfaces, and not grinding the second cutting edge portions of each of the side surfaces, so that the cutting insert, when placed in a drill, provides a desired drill diameter.
